(19) United States
(12) Patent Application Publication
(10) Pub. No.: US 2007/0138312 A1
(43) Pub. Date: Jun. 21, 2007

(54) Metal powder production apparatus

(75) Inventors: Koei Nakabayashi, Hachinohe (JP); Mitsutoyo Tanaka, Chino (JP); Tokihiro Shimura, Hachinohe (JP); Yoshinari Tanaka, Hachinohe (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/641,522

(22) Filed: Dec. 19, 2006

(30) Foreign Application Priority Data
Dec. 20, 2005 (JP) 2005-367230

(51) Int. Cl. B05B 17/04

(52) U.S. Cl. 239/11

(57) ABSTRACT

A metal powder production apparatus includes a nozzle having a first member and a second member by which an orifice for injecting water is defined. A first groove portion and a first easy-to-deform portion are formed in the first member and a second groove portion and a second easy-to-deform portion are formed in the second member. The nozzle is configured to ensure that the first member and the second member are deformed by the pressure of the water passing between the first member and the second member, whereby the orifice can be restrained from being enlarged by the pressure of the water passing through the orifice.

### CROSS-REFERENCE TO RELATED APPLICATION

This application claims priorities to Japanese Patent Application No. 2005-367230 filed on Dec. 20, 2005 which is hereby expressly incorporated by reference herein in its entirety.

### BACKGROUND

1. Technical Field

The present invention relates to a metal powder production apparatus for producing metal powder from molten metal.

2. Related Art

Conventionally, a metal powder production apparatus (atomizer) that pulverizes molten metal into metal powder by an atomizing method has been used in producing metal powder. Examples of the metal powder production apparatus known in the art include a molten metal atomizing and pulverizing apparatus disclosed in JP-B-3-55522.

The molten metal atomizing and pulverizing apparatus is provided with a molten bath nozzle for ejecting molten bath (molten metal) in a downward direction and a water nozzle having a flow path through which the molten bath ejected from the molten bath nozzle passes and a slit opened into the flow path. Water is injected from the slit of the water nozzle.

The apparatus of the prior art mentioned above is designed to produce metal powder by bringing the molten bath passing through the flow path into collision with the water injected from the slit to thereby disperse the molten bath in the form of a multiplicity of fine liquid droplets and then allowing the multiplicity of fine liquid droplets to be cooled and solidified.

However, in the apparatus of the prior art mentioned above, the clearance of the slit is excessively enlarged by the pressure of the water flowing therethrough. As a result, water pressure is dropped in the water nozzle. This water pressure drop causes a problem of overly reducing the flow velocity of the water injected from the slit. Therefore, since the ability for the fast-flowing water to pulverize the molten bath is decreased, fine-sizing of the metal powder cannot be made. This makes it difficult to obtain fine powder of a desired particle size.

### SUMMARY

Accordingly, it is an object of the present invention to provide a metal powder production apparatus capable of maintaining a flow velocity of fluid injected from an orifice nearly constant in a reliable manner.

One aspect of the invention is directed to a metal powder production apparatus. The metal powder production apparatus comprises a supply part for supplying molten metal and a nozzle provided below the supply part. The nozzle includes a flow path defined by an inner circumferential surface of the nozzle through which the molten metal supplied from the supply part can pass, the inner circumferential surface of the nozzle having a gradually reducing inner diameter portion whose inner diameter is gradually reduced in a downward direction, an orifice opened at a bottom end of the flow path and adapted to inject fluid toward the flow path, a retention portion for temporarily retaining the fluid, and an introduction path for introducing the fluid from the retention portion to the orifice.

The molten metal is dispersed and turned into a multiplicity of fine liquid droplets by bringing the molten metal passing through the flow path into contact with the fluid injected from the orifice of the nozzle, so that the multiplicity of fine liquid droplets are solidified to thereby produce metal powder.

Further, the nozzle includes a first member having the gradually reducing inner diameter portion and a second member provided below the first member with a space left between the first member and the second member. The orifice, the retention portion and the introduction path are defined by the first member and the second member.

The nozzle is configured to ensure that the first member and the second member are deformed by the pressure of the fluid passing between the first member and the second member, whereby the orifice can be restrained from being enlarged by the pressure of the fluid passing through the orifice.

According to the above metal powder production apparatus, since the orifice can be restrained from being enlarged by the pressure of the fluid passing through the orifice by deformation of the first member and the second member by the pressure of the fluid passing between the first member and the second member, it is possible to maintain the flow velocity of the fluid injected from the orifice nearly constant in a reliable manner.

It is preferred that the first member has a first groove portion and a first easy-to-deform portion and the second member has a second groove portion and a second easy-to-deform portion.

This makes it possible to maintain the flow velocity of the fluid injected from the orifice nearly constant in more reliable manner.

It is preferred that the first member has a first groove portion, a first easy-to-deform portion formed by reducing the thickness of the first member by forming the first groove portion, the first easy-to-deform portion exhibiting a decreased physical strength and capable of being deformed with ease, and a first center portion lying closer to the center axis of the flow path than the first easy-to-deform portion, the second member has a second groove portion, a second easy-to-deform portion formed by reducing the thickness of the second member by forming the second groove portion, the second easy-to-deform portion exhibiting a decreased physical strength and capable of being deformed with ease, and a second center portion lying closer to the center axis of the flow path than the second easy-to-deform portion, and the first center portion is displaced about the first easy-to-deform portion and the second center portion is displaced about the second easy-to-deform portion so as to follow the movement of the first center portion, whereby the orifice can be restrained from being enlarged by the pressure of the fluid passing through the orifice.

This makes it possible to maintain the flow velocity of the fluid injected from the orifice nearly constant in more reliable manner.

It is preferred that the orifice is opened in a circumferential slit shape extending over the inner circumferential surface of the nozzle.

This ensures that the fluid is injected in a generally conical contour with an apex thereof lying definitely at the lower side.

It is preferred that the orifice has an inner circumferential surface defined by the first member and an outer circumferential surface defined by the second member.

This makes it possible to easily and reliably form the orifice. Furthermore, the size of the orifice can be properly set in accordance with the size of the space left between the first member and the second member.

It is preferred that the orifice is configured to ensure that the fluid is injected in a generally conical contour with an apex lying at a lower side.

This ensures that the molten metal is dispersed within the fluid injected in a generally conical contour and is turned to a multiplicity of fine fluid droplets in a reliable manner.

It is preferred that the introduction path has a vertical cross-section of a wedge shape.

This makes it possible to gradually increase the flow velocity of the fluid. It is also possible to stably inject the fluid having an increased velocity from the orifice.

It is preferred that the gradually reducing inner diameter portion is of a convergent shape.

This ensures that the air subsisting above the nozzle flows into (or is sucked up into) the gradually reducing inner diameter portion together with the stream of fluid injected from an orifice. The air thus introduced exhibits a greatest flow velocity near a smallest inner diameter section of the gradually reducing inner diameter portion. Under an action of the air whose flow velocity has become greatest, the molten metal is dispersed and turned to a multiplicity of fine liquid droplets in a reliable manner.

It is preferred that the first groove portion is formed in an annular shape at the first member corresponding to the gradually reducing inner diameter portion along the circumferential direction threrof.

This ensures that the first easy-to-deform portion is formed along the circumference of the gradually reducing inner diameter portion, whereby the first center portion can be uniformly displaced at all parts in the circumferential direction thereof.

It is preferred that the first groove portion is formed in an annular shape at the bottom portion of the first member defining the retention portion near the introduction path along the circumferential direction of the gradually reducing inner diameter portion.

This ensures that the first easy-to-deform portion is formed along the circumference of the gradually reducing inner diameter portion, whereby the first center portion can be uniformly displaced at all parts in the circumferential direction thereof.

It is preferred that the second groove portion is formed in an annular shape at the bottom portion of the second member corresponding to a region near the orifice along the circumferential direction of the gradually reducing inner diameter portion.

This ensures that the second easy-to-deform portion is formed along the circumference of the gradually reducing inner diameter portion, whereby the second center portion can be uniformly displaced at all parts in the circumferential direction thereof.

It is preferred that the second groove portion is formed in an annular shape at the top portion of the second member defining the retention portion near the introduction path along the circumferential direction of the gradually reducing inner diameter portion.

This ensures that the second easy-to-deform portion is formed along the circumference of the gradually reducing inner diameter portion, whereby the second center portion can be uniformly displaced at all parts in the circumferential direction thereof.

It is preferred that the first groove portion has a vertical cross-section of a generally triangular shape.

This makes it possible to maintain the flow velocity of the fluid injected from the orifice nearly constant in more reliable manner.

It is preferred that the second groove portion has a vertical cross-section of a generally triangular shape.

This makes it possible to maintain the flow velocity of the fluid injected from the orifice nearly constant in more reliable manner.

It is preferred that the orifice is restrained from being enlarged by a pressure to the second member applied by the fluid which flows into the retention portion and a pressure to the first member applied by the fluid whose flowing direction is changed by the second member.

This makes it possible to maintain the flow velocity of the fluid injected from the orifice nearly constant in a reliable manner.

The above and other objects, features and advantages of the present invention will become apparent from the following description of preferred embodiments given in conjunction with the accompanying drawings.

### BRIEF DESCRIPTION OF THE DRAWINGS

FIG. 1 is a vertical sectional view showing a metal powder production apparatus in accordance with a first embodiment of the present invention.

FIG. 2 is an enlarged detail view of a region [A] enclosed by a single-dotted chain line in FIG. 1.

FIG. 3 is a vertical sectional view showing a metal powder production apparatus in accordance with a second embodiment of the present invention.

### DESCRIPTION OF EXEMPLARY EMBODIMENTS

Hereinafter, a metal powder production apparatus in accordance with the present invention will be described in respect of preferred embodiments shown in the accompanying drawings.

### First Embodiment

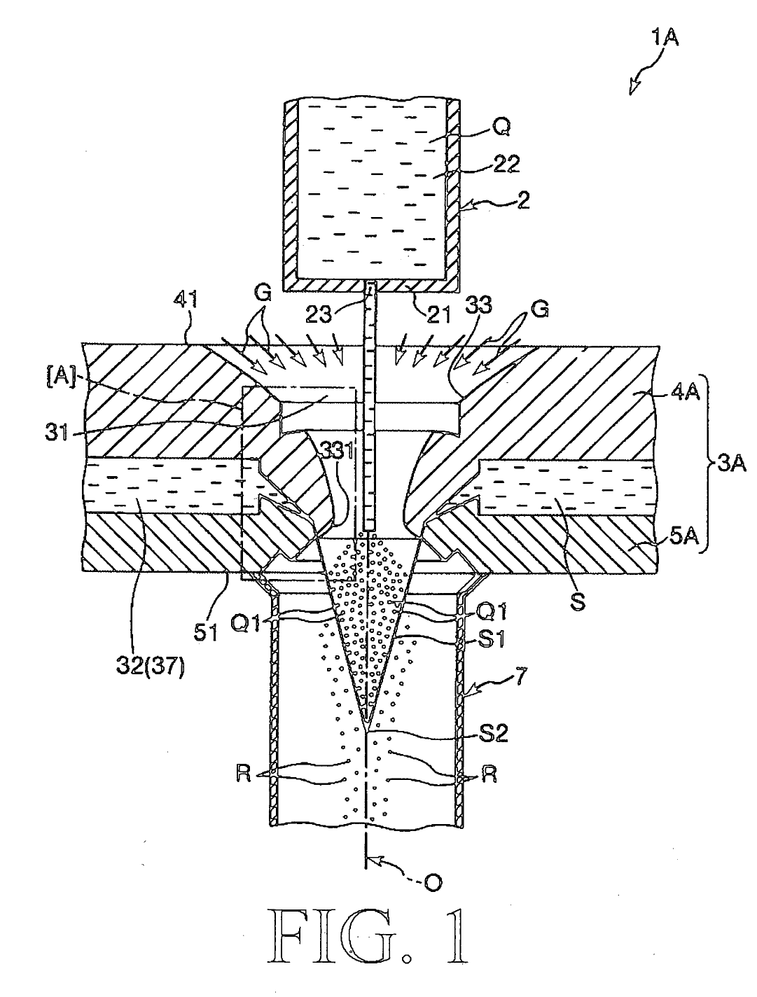

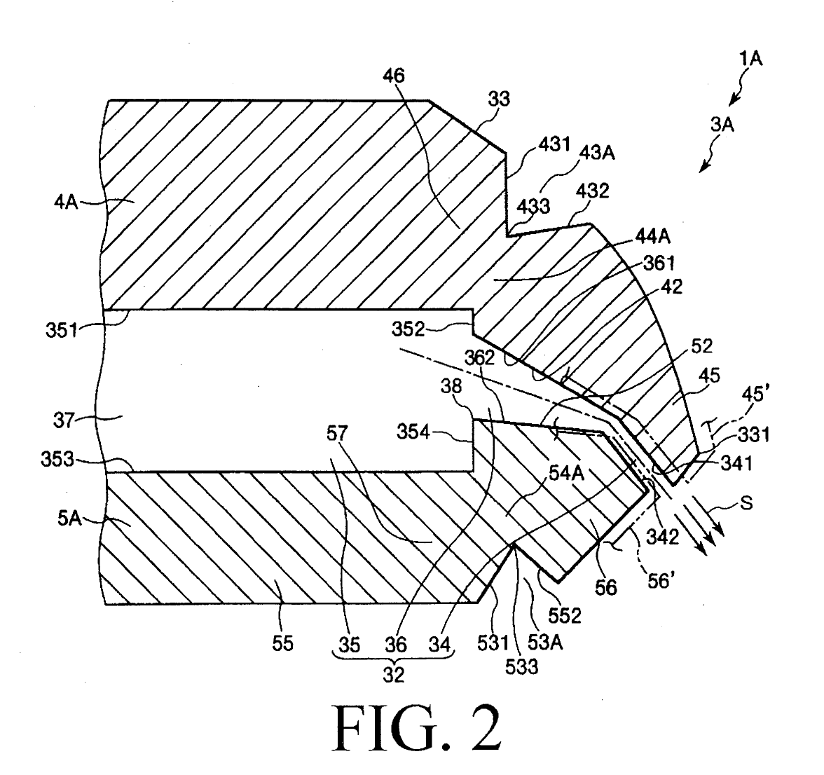

FIG. 1 is a vertical sectional view showing a metal powder production apparatus in accordance with a first embodiment of the present invention, FIG. 2 is an enlarged detail view of a region [A] enclosed by a single-dotted chain line in FIG. 1.

In the following description, the upper side in FIGS. 1 and 2 will be referred to as “top” or “upper” and the lower side will be referred to as “bottom” or “lower”, only for the sake of better understanding.

The metal powder production apparatus (atomizer) 1A shown in FIG. 1 is an apparatus that pulverizes molten metal Q by an atomizing method to obtain a multiplicity of metal powder particles R. The metal powder production apparatus 1A includes a supply part 2 for supplying the molten metal Q, a nozzle 3 provided below the supply part 2, a heat insulating layer 6 formed on the nozzle 3A, and a cover 7 attached to a bottom end surface 51 of the nozzle 3A (namely, the second member 5A).

Taken as an example in the present embodiment is a case that the metal powder production apparatus 1A produces metal powder particles R made of stainless steel (e.g., 304L, 316L, 17-4PH, 440C or the like) or Fe-Si-based magnetic material.

Now, description will be given to the configuration of individual parts.

As shown in FIG. 1, the supply part 2 has a portion of a bottom-closed tubular shape. In an internal space (cavity portion) 22 of the supply part 2, there is temporarily stored the molten metal Q (a molten material) obtained by mixing a simple substance of Co and a simple substance of Sn at a predetermined mol ratio (e.g., a mol ratio of 1:2) and melting them.

Furthermore, an ejection port 23 is formed at the center of a bottom portion 21 of the supply part 2. The molten metal Q in the internal space 22 is downwardly ejected from the ejection port 23.

The nozzle 3A is arranged below the supply part 2. The nozzle 3A is provided with a first flow path 31 through which the molten metal Q supplied (ejected) from the supply part 2 passes and a second flow path 32 through which water S supplied from a water source (not shown) for supplying fluid (water or liquid S in the present embodiment) passes.

The first flow path 31 has a circular cross-section and extends in a vertical direction at the center of the nozzle 3A. The first flow path 31 is defined by an inner circumferential surface of the nozzle 3. The inner circumferential surface of the nozzle 3 has a gradually reducing inner diameter portion 33 of a convergent shape whose inner diameter is gradually decreased from a top end surface 41 of the nozzle 3A toward the bottom thereof. Specifically a first member 4A which will be described hereinafter has the gradually reducing inner diameter portion 33.

Thus, the air (gas) G subsisting above the nozzle 3A flows into (or is sucked up into) the gradually reducing inner diameter portion 33 (the first flow path 31) together with the stream of water (fluid) S injected from an orifice 34, which will be describe later. The air G thus introduced exhibits a greatest flow velocity near a smallest inner diameter section 331 of the gradually reducing inner diameter portion 33 (near a section at which the orifice 34 is opened). Under an action of the air G whose flow velocity has become greatest, the molten metal Q is dispersed and turned to a multiplicity of fine liquid droplets Q1 in a reliable manner.

As illustrated in FIG. 2, the second flow path 32 is formed of an orifice 34 opened toward a bottom end portion (the vicinity of the smallest inner diameter section 331) of the first flow path 31, a retention portion 35 for temporarily retaining the water S, and an introduction path (interconnecting path) 36 through which the water S is introduced from the retention portion 35 into the orifice 34.

The retention portion 35 is connected to the water source to receive the water S therefrom. The retention portion 35 communicates with the orifice 34 through the introduction path 36.

Furthermore, the retention portion 35 has a vertical cross-section of a rectangular (or square) shape.

The introduction path 36 is a region whose vertical cross-section is of a wedge-like shape. This makes it possible to gradually increase the flow velocity of the water S flowing into the introduction path 36 from the retention portion 35 and, hence, to stably inject the water S with an increased flow velocity from the orifice 34.

The orifice 34 is a region at which the water S passed the retention portion 35 and the introduction path 36 in sequence is injected or spouted into the first flow path 31.

The orifice 34 is opened in a circumferential slit shape extending over the inner circumferential surface of the nozzle 3. Furthermore, the orifice 34 is opened in an inclined direction with respect to a center axis 0 of the first flow path 31.

By virtue of the orifice 34 formed in this manner, the water S is injected as a liquid jet S1 of a generally conical contour with an apex S2 thereof lying definitely at the lower side (see FIG. 1). This ensures that, in and inside the liquid jet S1, the molten metal Q is dispersed and turned to the multiplicity of fine liquid droplets Q1 in a reliable manner.

As set forth above, the molten metal Q is further dispersed and turned to the multiplicity of fine liquid droplets Q1 in a reliable manner, by the Air G whose flow velocity becomes greatest near the smallest inner diameter section 331 of the gradually reducing inner diameter portion 33. This generates a synergistic effect by which the molten metal Q is reliably dispersed and turned to the multiplicity of fine liquid droplets Q1 in more reliable manner.

The molten metal Q turned to the multiplicity of liquid droplets Q1 is cooled and solidified by making contact with the liquid jet S1, whereby a multiplicity of metal powder particles R are produced. The multiplicity of metal powder particles R thus produced are received in a container (not shown) arranged below the metal powder production apparatus 1A.

The nozzle 3A in which the first flow path 31 and the second flow path 32 are formed includes a first member 4A of a disk-like shape (ring-like shape) and a second member 5A of a disk-like shape (ring-like shape) arranged concentrically with the first member 4A (see FIGS. 1 and 2). The second member 5A is arranged below the first member 4A with a space 37 left therebetween.

The orifice 34, the introduction path 36 and the retention portion 35 are respectively defined by the first member 4A and the second member 5A arranged in this way. That is to say, the second flow path 32 is provided by the space 37 formed between the first member 4A and the second member 5A.

As illustrated in FIG. 2, the orifice 34 has an inner circumferential surface 341 defined by a bottom portion 42 of the first member 4A and an outer circumferential surface 342 defined by a top portion 52 of the second member 5A.

Likewise, the introduction path 36 has an upper surface 361 defined by the bottom portion 42 of the first member 4A and a lower surface 362 defined by the top portion 52 of the second member 5A.

Moreover, the retention portion 35 has an upper surface 351 and an inner circumferential surface 352 lying above the introduction path 36, both of which are defined by the bottom portion 42 of the first member 4A, and a lower surface 353 and an inner circumferential surface 354 lying below the introduction path 36, both of which are defined by the top portion 52 of the second member 5A.

By defining the orifice 34, the introduction path 36 and the retention portion 35 in this manner, it is possible to easily and reliably form the orifice 34, the introduction path 36 and the retention portion 35 in the nozzle 3A. Furthermore, the size of the orifice 34, the introduction path 36 and the retention portion 35 can be properly set in accordance with the size of the space 37.

Examples of a constituent material of the first member 4A and the second member 5A include, but are not particularly limited to, a variety of metallic materials. In particular, use of stainless steel is preferred, and use of Cr-based stainless steel or precipitation hardening stainless steel is more preferred.

As shown in FIG. 1, the cover 7 formed of a tubular body is fixedly secured to a bottom end surface 51 of the second member 5A. The cover 7 is arranged concentrically with the first flow path 31. Use of the cover 7 makes it possible to prevent the metal powder particles R from flying apart as they fall down, whereby the metal powder particles R can be reliably received the container.

As illustrated in FIG. 2 (also in FIG. 1), a first groove portion 43A and a first easy-to-deform portion 44A are formed in the first member 4A. Furthermore, a second groove portion 53A and a second easy-to-deform portion 54A are formed in the second member 5A.

The first groove portion 43A is formed by cutting away a part of the first member 4A corresponding to the gradually reducing inner diameter portion 33. Namely, the first groove portion 43A is formed at the first member 4A corresponding to the gradually reducing inner diameter portion 33.

The thickness of the first member 4A is reduced by the first groove portion 43A. The thickness-reduced region exhibits a decreased physical strength and can be deformed with ease, thus forming the first easy-to-deform portion 44A.

Due to the fact that the first easy-to-deform portion 44A is easily deformable, a first center portion 45 lying closer to the center axis O of the first flow path 31 than the first easy-to-deform portion 44A (lying at the right side of the first easy-to-deform portion 44A in FIG. 2) can be easily and reliably displaced about the first easy-to-deform portion 44A (see the first center portion 45′ depicted by a double-dotted chain line in FIG. 2).

The first groove portion 43A is formed in an annular shape over the entire circumference of the gradually reducing inner diameter portion 33. Thus, the first easy-to-deform portion 44A is formed along the circumference of the gradually reducing inner diameter portion 33, whereby the first center portion 45 can be uniformly displaced at all parts in the circumferential direction thereof.

As shown in FIG. 2, the first groove portion 43A is positioned at the inner side (at the side closer to the center axis O), i.e., at the right side in FIG. 2, with respect to the boundary 38 between the retention portion 35 and the introduction path 36.

The first groove portion 43A has a vertical cross-section of a triangular shape. This allows the first easy-to-deform portion 44A to be deformed so that two oblique surfaces 431 and 432 of the first groove portion 43A can come close to each other, namely, the apex angle at an apex point 433 of the first groove portion 43A can be reduced. Thus, the first center portion 45 is capable of being displaced easily and reliably.

Although the first groove portion 43A is positioned at the inner side with respect to the boundary 38 in the illustrated configuration, the present invention is not limited thereto. Alternatively, the first groove portion 43A may be positioned at the outer side with respect to the boundary 38.

Furthermore, although the first groove portion 43A has a vertical cross-section of a triangular shape in the illustrated configuration, the present invention is not limited thereto. For example, the vertical cross-section of the first groove portion 43A may be of a “U”-like shape.

The second groove portion 53A is formed by cutting away a part of the bottom portion 55 of the second member 5A near the orifice 34. Namely, The second groove portion 53A is formed at the bottom portion 52 of the second member 5A corresponding to a region near the orifice 34.

The thickness of the second member 5A is reduced by the second groove portion 53A. The thickness-reduced region exhibits a decreased physical strength and can be deformed with ease, thus forming the second easy-to-deform portion 54A.

Seeing the fact that the second easy-to-deform portion 54A is easily deformable, a second center portion 56 lying closer to the center axis O of the first flow path 31 than the second easy-to-deform portion 54A of the second member 5A can be displaced so as to follow the movement of the first center portion 45′ (see the second center portion 56′ depicted by a double-dotted chain line in FIG. 2).

The second groove portion 53A is formed in an annular shape along the circumferential direction of the gradually reducing inner diameter portion 33. Thus, the second easy-to-deform portion 54A is formed along the circumference of the gradually reducing inner diameter portion 33, whereby the second center portion 56 can be uniformly displaced at all parts in the circumferential direction thereof.

As shown in FIG. 2, the second groove portion 53A is positioned at the inner side, i.e., at the right side in FIG. 2, with respect to the boundary 38 between the retention portion 35 and the introduction path 36.

The second groove portion 53A has a vertical cross-section of a triangular shape. This allows the second easy-to-deform portion 54A to be deformed so that two oblique surfaces 531 and 532 of the second groove portion 53A can move away from each other, namely, the apex angle at an apex point 533 of the second groove portion 53A can be increased. Thus, the second center portion 56 is capable of being displaced easily and reliably.

Although the second groove portion 53A is positioned at the inner side with respect to the boundary 38 in the illustrated configuration, the present invention is not limited thereto. Alternatively, the second groove portion 53A may be positioned at the outer side with respect to the boundary 38.

Furthermore, although the second groove portion 53A has a vertical cross-section of a triangular shape in the illustrated configuration, the present invention is not limited thereto. For example, the vertical cross-section of the second groove portion 53A may be of a “U”-like shape.

With the metal powder production apparatus 1A of the configuration noted above, as the water S is injected from the orifice 34, the inner circumferential surface 341 and the outer circumferential surface 342 are pushed by the pressure of the water S passing through the orifice 34. As a result, the orifice 34 is urged to become enlarged.

However, in the metal powder production apparatus 1A, when the water S is injected from the orifice 34, the first center portion 45 is displaced about the first easy-to-deform portion 44A into the phantom line position 45′ under the pressure of the water S passing through the vicinity of the boundary 38, the introduction path 36 and the orifice 34 (see FIG. 2). As with the first center portion 45, the second center portion 56 is also displaced into the phantom line position 56′ under the pressure of the water S so as to follow the movement of the first center portion 45 displaced into the phantom line position 45′.

As described above, the metal powder production apparatus 1A is configured to ensure that each of the first center portion 45 (the first member 4A) and the second center portion 56 (the second member 5A) can be displaced or deformed. That is to say, in the metal powder production apparatus 1A, the second member 5A is pressured by the water S which flows into the retention portion 35 and the first member 4A is pressured by the water S whose flowing direction is changed by the second member 5A.

This restrains enlargement of the orifice 34. Thus, it is possible to maintain the size of the orifice 34 constant, whereby the flow velocity of the water S injected from the orifice 34 can be kept constant in a reliable manner.

### Second Embodiment

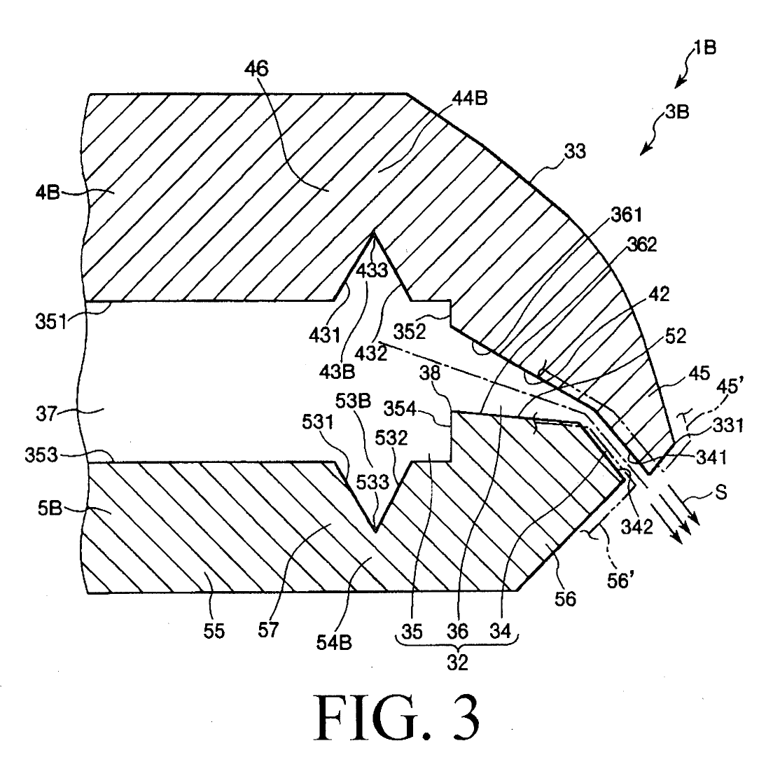

FIG. 3 is a vertical sectional view showing a metal powder production apparatus in accordance with an second embodiment of the present invention.

In the following description, the upper side in FIG. 3 will be referred to as “top” or “upper” and the lower side will be referred to as “bottom” or “lower”, only for the sake of better understanding.

Hereinafter, a metal powder production apparatus in accordance with a second embodiment of the present invention will be described with reference to this figure. The following description will be centered on the points differing from the foregoing embodiments, with the same points omitted from description.

The present embodiment is the same as the first embodiment, except for difference in the position of formation of the first groove portion and the second groove portion.

With the nozzle 3B of the metal powder production apparatus 1B shown in FIG. 3, a first groove portion 43B and a first easy-to-deform portion 44B are formed in the first member 4B, and a second groove portion 53B and a second easy-to-deform portion 54B are formed in the second member 5B.

The first groove portion 43B is formed in an annular shape at the bottom portion 42 of the first member 4B defining the retention portion 35 near the introduction path 36 along the circumferential direction of the gradually reducing inner diameter portion 33. Thus, the first easy-to-deform portion 44B is formed along the circumference of the gradually reducing inner diameter portion 33, whereby the first center portion 45 can be uniformly displaced at all parts in the circumferential direction thereof.

The first easy-to-deform portion 44B is deformed so that two oblique surfaces 431 and 432 of the first groove portion 43B can move away from each other, namely, the apex angle at an apex point 433 of the first groove portion 43B can be increased. Thus, the first center portion 45 is capable of being displaced easily and reliably.

The first groove portion 43B is positioned at the outer side, i.e., at the left side in FIG. 3, with respect to the boundary 38 between the retention portion 35 and the introduction path 36.

Although the first groove portion 43B is positioned at the outer side with respect to the boundary 38 in the illustrated configuration, the present invention is not limited thereto. Alternatively, the first groove portion 43B may be positioned or provided at the inner side with respect to the boundary 38, i.e., on the top surface 361 of the introduction path 36.

The second groove portion 53B is formed in an annular shape at the top portion 52 of the second member 5B defining the retention portion 35 near the introduction path 36 along the circumferential direction of the gradually reducing inner diameter portion 33. Thus, the second easy-to-deform portion 54B is formed along the circumference of the gradually reducing inner diameter portion 33, whereby the second center portion 56 can be uniformly displaced at all parts in the circumferential direction thereof.

The second easy-to-deform portion 54B is deformed so that two oblique surfaces 531 and 532 of the first groove portion 53B can come close to each other, namely, the apex angle at an apex point 533 of the second groove portion 53B can be reduced. Thus, the second center portion 56 is capable of being displaced easily and reliably.

The second groove portion 53B is positioned at the outer side with respect to the boundary 38 between the retention portion 35 and the introduction path 36.

Although the second groove portion 53B is positioned at the outer side with respect to the boundary 38 in the illustrated configuration, the present invention is not limited thereto. Alternatively, the second groove portion 53B may be positioned or provided at the inner side with respect to the boundary 38, i.e., on the bottom surface 362 of the introduction path 36.

As with the metal powder production apparatus 1A of the first embodiment described above, the metal powder production apparatus 1B is configured such that each of the first center portion 45 and the second center portion 56 can be displaced or deformed. This restrains enlargement of the orifice 34. Thus, it is possible to maintain the size of the orifice 34 constant, whereby the flow velocity of the water S injected from the orifice 34 can be kept constant in a reliable manner.

While the metal powder production apparatus of the present invention has been described hereinabove in respect of the illustrated embodiments, the present invention is not limited thereto. Individual parts constituting the metal powder production apparatus may be substituted by other arbitrary ones capable of performing like functions. Moreover, arbitrary constituent parts may be added if necessary.

Furthermore, the metal powder production apparatus of the present invention may be constructed by combining two or more arbitrary configurations (features) of the respective embodiments described above.

For example, the second groove portion of the first embodiment may be formed of the same one as the second groove portion of the second embodiment. Similarly, the first groove portion of the first embodiment may be formed of the same one as the first groove portion of the second embodiment.

In addition, although the liquid (fluid) injected from the nozzle is water in the foregoing embodiments, the present invention is not limited thereto. The liquid may be, e.g., lipids or solvents.

What is claimed is:

1. A metal powder production apparatus comprising:
a supply part for supplying molten metal; and
a nozzle provided below the supply part, the nozzle including a flow path defined by an inner circumferential surface of the nozzle through which the molten metal supplied from the supply part can pass, the inner circumferential surface of the nozzle having a gradually reducing inner diameter portion whose inner diameter is gradually reduced in a downward direction, an orifice opened at a bottom end of the flow path and adapted to inject fluid toward the flow path, a retention portion for temporarily retaining the fluid, and an introduction path for introducing the fluid from the retention portion to the orifice, the nozzle including a first member having the gradually reducing inner diameter portion and a second member provided below the first member with a space left between the first member and the second member, wherein the orifice, the retention portion and the introduction path are defined by the first member and the second member, whereby the molten metal is dispersed and turned into a multiplicity of fine liquid droplets by bringing the molten metal passing through the flow path into contact with the fluid injected from the orifice of the nozzle, so that the multiplicity of fine liquid droplets are solidified to thereby produce metal powder,
wherein the nozzle is configured to ensure that the first member and the second member are deformed by the pressure of the fluid passing between the first member and the second member, whereby the orifice can be restrained from being enlarged by the pressure of the fluid passing through the orifice.

2. The metal powder production apparatus as claimed in claim 1, wherein the first member has a first groove portion and a first easy-to-deform portion, and the second member has a second groove portion and a second easy-to-deform portion.

3. The metal powder production apparatus as claimed in claim 1, wherein the first member has a first groove portion, a first easy-to-deform portion formed by reducing the thickness of the first member by forming the first groove portion, the first easy-to-deform portion exhibiting a decreased physical strength and capable of being deformed with ease, and a first center portion lying closer to the center axis of the flow path than the first easy-to-deform portion,
wherein the second member has a second groove portion, a second easy-to-deform portion formed by reducing the thickness of the second member by forming the second groove portion, the second easy-to-deform portion exhibiting a decreased physical strength and capable of being deformed with ease, and a second center portion lying closer to the center axis of the flow path than the second easy-to-deform portion, and
wherein the first center portion is displaced about the first easy-to-deform portion and the second center portion is displaced about the second easy-to-deform portion so as to follow the movement of the first center portion, whereby the orifice can be restrained from being enlarged by the pressure of the fluid passing through the orifice.

4. The metal powder production apparatus as claimed in claim 1, wherein the orifice is opened in a circumferential slit shape extending over the inner circumferential surface of the nozzle.

5. The metal powder production apparatus as claimed in claim 4, wherein the orifice is configured to ensure that the fluid is injected in a generally conical contour with an apex lying at a lower side.

6. The metal powder production apparatus as claimed in claim 5, wherein the orifice has an inner circumferential surface defined by the first member and an outer circumferential surface defined by the second member.

7. The metal powder production apparatus as claimed in claim 1, wherein the introduction path has a vertical cross-section of a wedge shape.

8. The metal powder production apparatus as claimed in claim 1, wherein the gradually reducing inner diameter portion is of a convergent shape.

9. The metal powder production apparatus as claimed in claim 2, wherein the first groove portion is formed in an annular shape at the first member corresponding to the gradually reducing inner diameter portion along the circumferential direction threrof.

10. The metal powder production apparatus as claimed in claim 2, wherein the first groove portion is formed in an annular shape at the bottom portion of the first member defining the retention portion near the introduction path along the circumferential direction of the gradually reducing inner diameter portion.

11. The metal powder production apparatus as claimed in claim 2, wherein the second groove portion is formed in an annular shape at the bottom portion of the second member corresponding to a region near the orifice along the circumferential direction of the gradually reducing inner diameter portion.

12. The metal powder production apparatus as claimed in claim 2, wherein the second groove portion is formed in an annular shape at the top portion of the second member defining the retention portion near the introduction path along the circumferential direction of the gradually reducing inner diameter portion.

13. The metal powder production apparatus as claimed in claim 2, wherein the first groove portion has a vertical cross-section of a generally triangular shape.

14. The metal powder production apparatus as claimed in claim 2, wherein the second groove portion has a vertical cross-section of a generally triangular shape.

15. The metal powder production apparatus as claimed in claim 1, wherein the orifice is restrained from being enlarged by a pressure to the second member applied by the fluid which flows into the retention portion and a pressure to the first member applied by the fluid whose flowing direction is changed by the second member.
